(19) United States
(12) Patent Application Publication
(10) Pub. No.: US 2003/0092564 A1
(43) Pub. Date: May 15, 2003

(54) Metallocene catalyst supported on a molecular sieve having "tubules-within-a-tubule" morphology for preparing olefin polymer

(75) Inventors: Shu-Hua Chan, Hsinchu (TW); Ching Ting, Tainan (TW); Chung-Yuan Mou, Kaohsiung (TW); Hong-Ping Lin, Kaohsiung (TW)

Correspondence Address: SUGHRUE, MION, ZINN,, MACPEAK & SEAS, PLLC, 2100 Pennsylvania Avenue, N.W., Washington, DC, 20037-3213, US

(73) Assignee: INDUSTRIAL TECHNOLOGY RESEARCH INSTITUTE

(21) Appl. No.: 09/987,756

(22) Filed: Nov. 15, 2001

(51) Int. Cl. B01J 31/00

(52) U.S. Cl. 502/117; 502/150; 502/152; 502/154; 502/232; 502/237; 502/238

(57) ABSTRACT

The present invention provides a metallocene catalyst supported on a molecular seive having “tubules-within-a-tubule” morphology. When the metallocene catalyst is used for preparing polyolefin, the MAO amount can be decreased to an amount such that the molar ratio of Al/Zr is below 200. Thus, production costs are greatly reduced.

### BACKGROUND OF THE INVENTION

1. Field of the Invention

The present invention relates to a catalyst composition in which a metallocene is supported on a molecular sieve having “tubules-within-a-tubule” morphology, and more particularly to a process for preparing an olefin polymer in the presence of such a catalyst composition.

2. Background of the Invention:

Olefin-based polymers have been used in a wide range of applications. One group of commonly used olefin-based polymers is polyolefins, that is, homopolymers or copolymers of olefins. These polyolefin plastics are typically used in such applications such as blow and injection molding, extrusion coating, film and sheeting, pipe, wire and cable.

Polyolefin is generally prepared by subjecting one or more olefin monomers to polymerization in the presence of a supported metallocene catalyst and methyl aluminoxane (MAO) (serving as a cocatalyst). The so-called supported metallocene is a metallocene supported on an inorganic carrier such as porous alumina, silica, or alumisilicate. In order to attain the desirable catalytic activity for metallocene catalyst, the MAO amount must be high enough that the molar ratio of aluminum content in MAO to the center metal content in metallocene is higher than 200. This MAO amount inflates production costs.

### SUMMARY OF THE INVENTION

The object of the present invention is to provide a novel catalyst composition for preparing polyolefin. By means of the catalyst composition, the MAO amount can be decreased to an amount such that the molar ratio of Al/Zr is below 200. Thus, production costs are greatly reduced.

To achieve the above-mentioned object, the catalyst composition of the present invention includes a metallocene catalyst and a mesoporous molecular sieve.

The mesoporous molecular sieve of the present invention has tubules-within-a-tubule morphology and has the following composition:

M_{n/q}(AlₐSi_{b}O_{c})

wherein M is one or more ions of hydrogen, ammonium, alkali metals or alkaline earth metals, n is the charge of the composition excluding the M expressed as oxide, q is the weighted molar average valence of M, a and b are molar fractions of Al and Si, respectively, a+b=1, b>0, and c is a number from 1 to 2.5.

The molecular sieve has a microstructure composed of microparticles in a hexagonal arrangement of uniformly-sized pores having a diameter of 1.3-100 nm and exhibiting a hexagonal electron diffraction pattern that can be indexed with a d₁₀₀ value greater than 1.8 nm.

About 30-100% of the microparticles are in substantially tubular form, with a diameter of 0.1-20 μm, and a wall comprising coaxial uniformly-sized pores having a diameter of 1.3-100 nm exhibiting a hexagonal electron diffraction pattern that can be indexed with a d₁₀₀ value greater than 1.8 nm.

### DETAILED DESCRIPTION OF THE INVENTION

The present invention uses a particular mesoporous molecular sieve as a carrier to support a metallocene catalyst. Specifically, the present invention uses a mesoporous molecular sieve developed and synthesized by Mou in U.S. Pat. No. 5,876,690.

It is known that MCM-41 is a mesoporous molecular sieve having hexagonal tubules with a diameter of 1.5 to 10.0 nm. The morphology of Mou's mesoporous molecular sieve is different from conventional MCM-41 in its “tubules-within-a-tubule” hierarchical order morphology. The morphology of the Mou molecular sieve provides a better mass tranfer effect. Thus, the invention uses Mou's particular mesoporous molecular sieve as a carrier to support a metallocene catalyst to prepare polyolefin. The following examples of the present invention show that the cocatalyst MAO amount can be decreased when the mesoporous molecular sieve is used as a carrier as opposed to the use of conventional silica as a carrier.

The mesoporous molecular sieve used in the present invention has tubules-within-a-tubule morphology and has the following composition:

M_{n/q}(AlₐSi_{b}O_{c})

wherein M is one or more ions of hydrogen, ammonium, alkali metals and alkaline earth metals, n is the charge of the composition excluding the M expressed as oxide, q is the weighted molar average valence of M, a and b are molar fractions of Al and Si, respectively, a+b=1, b>O, and c is a number from 1 to 2.5.

The mesoporous molecular sieve used in the present invention has a microstructure composed of microparticles having a hexagonal arrangement of uniformly-sized pores having a diameter of 1.3-100 nm and exhibiting a hexagonal electron diffraction pattern that can be indexed with a d₁₀₀ value greater than 1.8 nm.

A feature of the mesoporous silicate molecular sieve used in the present invention is that about 30-100% of the microparticles are in substantially tubular form. These substantially tubular microparticles have a diameter of 0.1-20 μm, and a wall including coaxial uniformly-sized pores having a diameter of 1.3-100 nm and exhibiting a hexagonal electron diffraction pattern that can be indexed with a d₁₀₀ value greater than 1.8 nm.

Preferably, the tubules-within-a-tubules (TWT) mesoporous molecular sieve has from 70 to 100% of the microparticles in the substantially tubular form, and the substantially tubular microparticles have a diameter of 0.1-5 μm.

In the composition M_{n/q}(AlₐSi_{b}O_{c}) of the molecular sieve, M is preferably an alkali metal ion, for example, sodium ion.

The TWT mesoporous molecular sieve used in the present invention can be a pure silicate molecular sieve or an aluminosilicate molecular sieve. That is to say, in the composition M_{n/q}(AlₐSi_{b}O_{c}), b is larger than 0, but a can be 0. Preferably, the mesoporous molecular sieve has a SiO₂:Al₂O₃ molar ratio ranging from 1:0 to 1:0.2.

According to the present invention, the metallocene is supported on the TWT mesoporous molecular sieve. The metallocene can be a bis (unsubstituted or substituted cyclopentadienyl) metal compound or a mono (unsubstituted or substituted cyclopentadienyl) metal compound.

When the metallocene is a bis (unsubstituted or substituted cyclopentadienyl) metal compound, it can be a bridged metallocene represented by the formula R(Z) (Z)MeQₖ and an unbridged metallocene represented by the formula (Z) (Z)MeQₖ, wherein each Z is bound to Me and L is the same or different and is a ligand selected from substituted or unsubstituted cyclopentadienyl, substituted or unsubstituted indenyl, substituted or unsubstituted tetrahydroindenyl, substituted or unsubstituted octahydrofluorenyl, substituted or unsubstituted benzofluorenyl, substituted or unsubstituted fluorenyl ligands, and alkyl substituted cyclopentadienyl derivatives; R is a structural bridge linking the Z's and Me is a metal selected from the gorup consisting of IVB, VB, and VIB metals of the Periodic Table, each Q is the same or different and is selected from the group consisting of hydrogen, halogens, and organoradicals; k is a number sufficient to fill out the remaining valences of Me.

When Q is an organoradical, it can be alkyl, amino (—NH₂), alkylamino (such as —N(CH₃)₂), amido (—(C═O)NH₂), or alkylamido.

When the metallocene is a bridged bis (unsubstituted or substituted cyclopentadienyl) metal compound, representative examples, but not limiting, include

ethylene-1,2-bis(η⁵-1-indenyl)titanium dichloride,

ethylene-1,2-bis(η⁵-1-indenyl)titanium dimethyl,

ethylene-1,2-bis(η⁵-1-indenyl)hafnium dichloride,

ethylene-1,2-bis(η⁵-1-indenyl)hafnium dimethyl,

isopropylidene(η⁵-9-fluorenyl) (η⁵-1-cyclopentadienyl)zirconium dichloride,

isopropylidene(η⁵-9-fluorenyl) (η⁵-1-cyclopentadienyl)zirconium dimethyl,

dimethylsilyl (η⁵-9-fluorenyl) (η⁵-1-cyclopentadienyl)zirconium dichloride,

dimethylsilyl(η⁵-9-fluorenyl)(η⁵-1-cyclopentadienyl)zirconium dimethyl,

propylenesilyl-bis(η⁵-cyclopentadienyl) zirconium dichloride, and propylenesilyl-bis(η⁵-cyclopentadienyl) bis(dimethylamino)zirconium.

When the metallocene is an unbridged bis (unsubstituted or substituted cyclopentadienyl) metal compound, representative examples include

bis(η⁵-cyclopentadienyl)zirconium dichloride,

bis(η⁵-cyclopentadienyl)zirconium dimethyl,

bis(η⁵-cyclopentadienyl)titanium dichloride,

bis(η⁵-cyclopentadienyl)titanium dimethyl,

bis(η⁵-cyclopentadienyl)hafnium dichloride,

bis(η⁵-cyclopentadienyl)hafnium dimethyl,

bis(pentamethyl-η⁵-cyclopentadienyl)zirconium dichloride,

bis(pentamethyl-η⁵-cyclopentadienyl)zirconium dimethyl,

bis(pentamethyl-η⁵-cyclopentadienyl)titanium dichloride,

bis(pentamethyl-η⁵-cyclopentadienyl)titanium dimethyl,

bis(pentamethyl-η⁵-cyclopentadienyl)hafnium dichloride,

bis(pentamethyl-η⁵-cyclopentadienyl)hafnium dimethyl,

bis(η⁵-1-indenyl)zirconium dichloride, and

bis(η⁵-1-indenyl)zirconium dimethyl.

When the metallocene is a mono(unsubstitued or substituted cyclopentadienyl) metal compound, representative examples include

η⁵-cyclopentadienyltitanium trichloride,

η⁵-cyclopentadienyltitanium trimethyl, (tert-butylamido)dimethyl(tetramethyl-η⁵-cyclopentadienyl)silanetitanium dichloride,

(tert-butylamido)dimethyl(tetramethyl-η⁵-cyclopentadienyl)silanetitanium dimethyl,

(tert-butylamido)dimethyl(tetramethyl-η⁵-cyclopentadienyl)silanezirconium dichloride,

(tert-butylamido)dimethyl(tetramethyl-η⁵-cyclopentadienyl)silanezirconium dimethyl,

(tert-butylamido)dimethyl(tetramethyl-η⁵-cyclopentadienyl)methanetitanium dichloride,

(tert-butylamido)dimethyl(tetramethyl-η⁵-cyclopentadienyl)methanetitanium dimethyl,

(tert-butylamido)dimethyl(tetramethyl-η⁵-cyclopentadienyl)methanezirconium dichloride, and

(tert-butylamido)dimethyl(tetramethyl-η⁵-cyclopentadienyl)methanezirconium dimethyl.

The catalyst composition of the present invention can further include an activating cocatalyst, which can be methyl aluminoxane (MAO), alkyl aluminoxane, a trialkyl aluminum, a dialkyl aluminum halide, a salt of an inert and non-coordinating anion, or mixtures thereof. The trialkyl aluminum can be selected from the group consisting of dimethylethyl aluminum (Me₂EtAl), trimethyl aluminum, triethyl aluminum, tripropyl aluminum, trisopropyl aluminum, tributyl aluminum, and triisobutyl aluminum (triisobutyl/aluminoxane) (TIBA).

Among these cocatalysts, MAO is preferable. When MAO is used, by means of the catalyst composition of the present invention, the MAO amount can be decreased to an amount such that the molar ratio of aluminum content in methyl aluminoxane to the metal content in the metallocene is from 0 to 200, preferably 50 to 150.

By using the catalyst composition of the present invention, an olefin polymer can be synthesized. In the presence of a catalytically effective amount of the catalyst composition of the present invention under polymerizing conditions, an olefin can be polymerized (i.e., homopolymerized), or an olefin together with at least one monomer different from the olefin can be polymerized (i.e., copolymerized). The at least one monomer copolymerized may be or may not be of olefin type.

Suitable olefins include ethylene, propylene, butadiene, isoprene, and styrene. According to a preferred embodiment of the present invention, a novel type of polyethylene with high crystallinity (having a melting point higher than 140° C.) in low Mw range (in a weight molecular weight range less than 1,000,000) can be obtained.

Moreover, since the mesoporous molecular sieve of the present invention has a special tubules-within-a-tubule morphology, it has space confine effect. Therefore, it is suitable for preparing a structure regulated polymer (stereoselective polymer) by using the tubules-within-a-tubule mesoporous molecular sieve as a carrier. Representive examples of such structure regulated polymers include high isotactic polypropylene, high cis polybutadiene, high cis polyisoprene, syndiotactic polystyrene, and a copolymer of a styrenic monomer and a diene.

The catalyst composition of the present invention can be used in slurry reaction conditions, gas phase, and solution polymerization reaction conditions. Polymerization is typically carried out at a temperature of 0° to 250° C., and an atmospheric pressure up to 3,000 psi.

The following examples are intended to illustrate the process and the advantages of the present invention more fully without limiting its scope, since numerous modifications and variations will be apparent to those skilled in the art.

### Synthesis of Supports

### PRELIMINARY EXAMPLE 1

### Tubules-Within-A-Tubule MCM-41 (TWT-MCM-41)

6.85 g of C₁₆TMAB (cetyltrimethylammonium bromide) was dissolved in 37.5 g of water at 32° C. and stirred at 400 rpm. 0.1 g of NaAlO₂ (sodium aluminate) was dissolved in 5 g of water and then added to the above C₁₆TMAB solution. 8.8 g of sodium silicate was added to the above mixed solution. 10.5 g of 1.20 M sulfuric acid aqueous solution was added by pipette very slowly in a total time of 30 minutes to cause gradual polymerization of sodium silicate. The pH of the final mixture was 10-9.

The gel solution formed was stirred for 20 minutes and then poured into a stainless steel autoclave. The gel solution was allowed to stand for 20 minutes and then heated at 100° C. for 48 hours. The solid product recovered by filtration was washed with deionized water two times (solid:water≅1:200), and then dried in ambient temperature or 100° C. to obtain an as-synthesized MCM-41 product.

The dried as-synthesized product was calcined at 560° C. in air at a heating rate of 1.5° C./min for 6 hours to remove the C₁₆TMAB template to obtain the final tubules-within-a-tubule (TWT) MCM-41 product.

### PRELIMINARY EXAMPLE 2

### Particulate MCM-41

The same procedures as described in Example 1 were employed except that the amounts of water, C₁₆TMAB, NaAlO₂, and sodium silicate were changed, such that the H₂O/C₁₆TMAB molar ratio was controlled to about 178, and the Si/Al molar ratio was controlled to about 37. Thus, the obtained MCM-41 was in particulate morphology, which was different from the morphology of the MCM-41 obtained from Example 1.

### Preparation of Catalyst Composition

### EXAMPLE C1

A 100 ml reactor was dried in an oven for several hours. 1.0 g of the TWT-MCM-41 obtained from Preliminary Example 1 and 30 ml of toluene were charged in the reactor in a dry box and stirred thoroughly. A Cp₂ZrCl₂ solution (0.19 g of Cp₂ZrCl₂ in 10 ml of toluene) was injected into the MCM-41 solution with a syringe and stirred at room temperature for 48 hours. After the reaction was complete, the reaction mixture was filtered and concentrated under reduced pressure to collect the solid catalyst.

### EXAMPLE C2

A 100 ml reactor was dried in an oven for several hours. 0.5 9 of the TWT-MCM-41 obtained from Premilinary Example 1 and 30 ml of toluene were charged in the reactor in a dry box and stirred thoroughly. A Cp₂ZrCl₂ solution (0.1 9 of Cp₂ZrCl₂ in 10 ml of toluene) was injected into the MCM-41 solution with a syringe and stirred at room temperature for 24 hours. Then, 15 ml of MAO (methyl aluminoxane) (1.4 M) was further added into the solution and stirred for another 24 hours. After the reaction was complete, the reaction mixture was filtered and concentrated under reduced pressure to collect the solid catalyst.

### EXAMPLE C3

A 100 ml reactor was dried in an oven for several hours. 0.5 g of the TWT-MCM-41 obtained from Preliminary Example 1 and 30 ml of toluene were charged in the reactor in a dry box and stirred thoroughly. 15 ml of MAO (1.4 M) was added into the MCM-41 solution and stirred for 24 hours. Then, a Cp₂ZrCl₂ solution (0.1 g of Cp₂ZrCl₂ in 10 ml of toluene) was injected into the solution with a syringe and stirred at room temperature for another 24 hours. After the reaction was complete, the reaction mixture was filtered and concentrated under reduced pressure to collect the solid catalyst.

### EXAMPLE C4

A 100 ml reactor was dried in an oven for several hours. 0.5 g of the TWT-MCM-41 obtained from Preliminary Example 1 and 30 ml of toluene were charged in the reactor in a dry box and stirred thoroughly. A Cp₂ZrCl₂ solution (0.1 g of Cp₂ZrCl₂ in 10 ml of toluene) and 15 ml of MAO (1.4 M) were previously mixed for 1 hour to give a metallocene solution. Then, the metallocene solution was injected into the MCM-41 solution with a syringe and stirred at room temperature for 48 hours. After the reaction was complete, the reaction mixture was filtered and concentrated under reduced pressure to collect the solid catalyst.

### COMPARATIVE EXAMPLE C1

### Catalyst Composition Containing Amorphous SiO₂

A 100 ml reactor was dried in an oven for several hours. 0.5 g of amorphous SiO₂ (containing 15 wt % of aluminum, under a trademark of SMAO, purchased from Witco Co.) and 30 ml of toluene were charged in the reactor in a dry box and stirred thoroughly. A Cp₂ZrCl₂ solution (0.1 g of Cp₂ZrCl₂ in 10 ml of toluene) was injected into the SiO₂ solution with a syringe and stirred at room temperature for 48 hours. After the reaction was complete, the reaction mixture was filtered and concentrated under reduced pressure to collect the solid catalyst.

### COMPARATIVE EXAMPLE C2

### Catalyst Composition Containing Particulate MCM-41

A 100 ml reactor was dried in an oven for several hours. 0.5 g of the particulate MCM-41 obtained from Preliminary Example 2 and 30 ml of toluene were charged in the reactor in a dry box and stirred thoroughly. A Cp₂ZrCl₂ solution (0.1 g of Cp₂ZrCl₂ in 10 ml of toluene) was injected into the SiO₂ solution with a syringe and stirred at room temperature for 48 hours. After the reaction was complete, the reaction mixture was filtered and concentrated under reduced pressure to collect the solid catalyst.

### Synthesis of Polyolefin

### COMPARATIVE EXAMPLE P1

### Polymerization Using Catalyst Supported on Amorphous Silica

The reactor vessel was heated to 80° C., evacuated for 1 hour, and introduced with nitrogen gas three times. 250 ml of toluene (water amount <10 ppm) was transferred into the reactor. 1 ml of TIBA (triisobutylaluminoxane) was charged into the reactor under nitrogen and stirred for 2 minutes and then 0.5 ml of MAO (1.49 M methyl aluminoxane) was charged. After the temperature was stabilized at 80° C., 16 mg of the catalyst composition prepared from Comparative Example C1 was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### COMPARATIVE EXAMPLE P2

### Polymerization Using Catalyst Supported on Particulate MCM-41 Support

The reactor vessel was heated to 80° C., evacuated for 1 hour, and introduced with nitrogen gas three times. 250 ml of toluene (water amount <10 ppm) was transferred into the reactor. 1 ml of TIBA (triisobutylaluminoxane) was charged into the reactor under nitrogen and stirred for 2 minutes and then 0.5 ml of MAO (1.49 M methyl aluminoxane) was charged. After the temperature was stabilized at 80° C., 16 mg of the catalyst composition prepared from Comparative Example C2 was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### COMPARATIVE EXAMPLE P3

### Polymerization Using Homogeneous Catalyst

The reactor vessel was heated to 80° C., evacuated for 1 hour, and introduced with nitrogen gas three times. 250 ml of toluene (water amount <10 ppm) was transferred into the reactor. 1 ml of TIBA (triisobutylaluminoxane) was charged into the reactor under nitrogen and stirred for 2 minutes and then 1 ml of MAO (1.49 M methyl aluminoxane) was charged. After the temperature was stabilized at 80° C., 1.6×10⁻⁶ mole of Cp₂ZrCl₂ (biscyclopentadienylzirconium dichloride) was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### EXAMPLE P1

The reactor vessel was heated to 80° C., evacuated for 1 hour, and introduced with nitrogen gas three times. 250 ml of toluene (water amount <10 ppm) was transferred into the reactor. 1 ml of TIBA (triisobutylaluminoxane) was charged into the reactor under nitrogen and stirred for 2 minutes and then 0.5 ml of MAO (1.49 M methyl aluminoxane) was charged. After the temperature was stabilized at 80° C., 16 mg of the catalyst composition prepared from Example C1 was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### EXAMPLE P2

The reactor vessel was heated to 80° C., evacuated for 1 hour, and introduced with nitrogen gas three times. 250 ml of toluene (water amount <10 ppm) was transferred into the reactor. After the temperature was stabilized at 800C, 16 mg of the catalyst composition prepared from Example C2 was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### EXAMPLE P3

The reactor vessel was heated to 80° C., evacuated for 1 hour, and introduced with nitrogen gas three times. 250 ml of toluene (water amount <10 ppm) was transferred into the reactor. After the temperature was stabilized at 80° C., 16 mg of the catalyst composition prepared from Example C3 was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

### EXAMPLE P4

The reactor vessel was heated to 80° C., evacuated for 1 hour, and introduced with nitrogen gas three times. 250 ml of toluene (water amount <10 ppm) was transferred into the reactor. After the temperature was stabilized at 80° C., 16 mg of the catalyst composition prepared from Example C4 was charged and stirred. Then, ethylene was introduced into the reactor and the reaction mixture was stirred at 600 rpm.

After the reaction was complete (about 30 minutes), the solution was cooled and methanol was added to precipitate the product. The product was filtered and dried in a 50° C. oven for various tests. The results obtained are shown in Table 1.

TABLE 1

| | | | | Catalytic | | |
|---|---|---|---|---|---|---|
| Example | | | | Activity | | |
| No. | Support | Al/Zr | Tm (° C.) | (g PE/g Zr·hr) | Mw | PDI |
| Comp. Exp. | Amorphous | 272 | 140 | 4.97 × 10⁴ | 175253 | 2.7 |
| P1 | SiO₂ | | | | | |
| Comp. Exp. | Particulate | 164 | 140 | 1.48 × 10⁴ | 169161 | 2.4 |
| P2 | MCM-41 | | | | | |
| Comp. Exp. | None | 931 | 137 | 8.3 × 10⁴ | 102705 | 2.0 |
| P3 | | | | | | |
| Exp. P1 | TWT-MCM-41 | 57 | 142.4 | 7.3 × 10⁴ | 150223 | 2.4 |
| Exp. P2 | TWT-MCM-41 | 126 | 143 | 7.86 × 10⁴ | 156048 | 2.7 |
| Exp. P3 | TWT-MCM-41 | 112 | 141.4 | 1.32 × 10⁵ | 134958 | 2.6 |
| Exp. P4 | TWT-MCM-41 | 156 | 139 | 1.32 × 10⁵ | 184956 | 2.4 |

From the results of Table 1, it can be learned that by using the catalyst composition of the present invention (Examples P1 to P4), that is, a metallocene supported on TWT-MCM-41, the Al/Zr ratio is greatly decreased compared with the conditions when a metallocene is supported either on amorphous silica (Comparative Example P1) or particulate MCM-41 (Comparative Example P2), or when a homogeneous metallocene is used (Comparative Example P3).

The foregoing description of the preferred embodiments of this invention has been presented for purposes of illustration and description. obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A catalyst composition comprising:
(a) a metallocene catalyst; and
(b) a mesoporous molecular sieve having tubules-within-a-tubule morphology and having the following composition:
M_{n/q}(AlₐSi_{b}O_{c})
wherein
M is one or more ions selected from the group consisting of hydrogen, ammonium, alkali metals and alkaline earth metals;
n is the charge of the composition excluding the M expressed as oxide;
q is the weighted molar average valence of M;
a and b are mole fractions of Al and Si, respectively, and a+b=1, and b>0; and
c is a number from 1 to 2.5;
the molecular sieve having a microstructure composed of microparticles with a hexagonal arrangement of uniformly-sized pores having a diameter of 1.3-100 nm and exhibiting a hexagonal electron diffraction pattern that can be indexed with a d₁₀₀ value greater than 1.8 nm, characterized in that about 30-100% of the microparticles are in substantially tubular form, the substantially tubular microparticles have a diameter of 0.1-20 μm, and the substantially tubular microparticles have a wall comprising coaxial uniformly-sized pores having a diameter of 1.3-100 nm and exhibiting a hexagonal electron diffraction pattern that can be indexed with a d₁₀₀ value greater than 1.8 nm.

2. The catalyst composition as claimed in claim 1, wherein the mesoporous silicate molecular sieve has from 70 to 100% of the microparticles being in the substantially tubular form, and the substantially tubular microparticles having a diameter of 0.1-5 gm.

3. The catalyst composition as claimed in claim 1, wherein M is an alkali metal ion.

4. The catalyst composition as claimed in claim 3, wherein M is a sodium ion.

5. The catalyst composition as claimed in claim 1, wherein the mesoporous silicate molecular sieve has a SiO₂:Al₂O₃ molar ratio ranging from 1:0 to 1:0.2.

6. The catalyst composition as claimed in claim 1, wherein the metallocene catalyst is selected from the group consisting of a bis (unsubstituted or substituted cyclopentadienyl) metal compound and a mono (unsubstituted or substituted cyclopentadienyl) metal compound.

7. The catalyst composition as claimed in claim 6, wherein the metallocene catalyst is a bis (unsubstituted or substituted cyclopentadienyl) metal compound and is selected from the group consisting of a bridged metallocene represented by the formula R(Z)(Z)MeQₖ and an unbridged metallocene represented by the formula (Z)(Z)MeQₖ,
wherein each Z is bound to Me and is the same or different and is a ligand selected from substituted or unsubstituted cyclopentadienyl, substituted or unsubstituted indenyl, substituted or unsubstituted tetrahydroindenyl, substituted or unsubstituted octahydrofluorenyl, substituted or unsubstituted benzofluorenyl, substituted or unsubstituted fluorenyl, and alkyl substituted cyclopentadienyl derivatives; R is a structural bridge linking the Z's and Me is a metal selected from the gorup consisting of IVB, VB, and VIB metals of the Periodic Table, each Q is the same or different and is selected from the group consisting of hydrogen, halogens, and organoradicals; k is a number sufficient to fill out the remaining valences of Me.

8. The catalyst composition as claimed in claim 7, wherein the metallocene catalyst is the bridged metallocene represented by the formula R(Z)(Z)MeQₖ, and is selected from the group consisting of
ethylene-1,2-bis(η⁵-1-indenyl)titanium dichloride,
ethylene-1,2-bis(η⁵-1-indenyl)titanium dimethyl,
ethylene-1,2-bis(η⁵-1-indenyl)hafnium dichloride,
ethylene-1,2-bis(η⁵-l-indenyl)hafnium dimethyl,
isopropylidene(η⁵-9-fluorenyl) (η⁵-1-cyclopentadienyl)zirconium dichloride,
isopropylidene(η⁵-9-fluorenyl) (η⁵-1-cyclopentadienyl)zirconium dimethyl,
dimethylsilyl(η⁵-9-fluorenyl) (η⁵-1-cyclopentadienyl)zirconium dichloride,
dimethylsilyl(η⁵-9-fluorenyl) (η⁵-1-cyclopentadienyl)zirconium dimethyl,
propylenesilyl-bis(η⁵-cyclopentadienyl)zirconium dichloride, and propylenesilyl-bis (η⁵-cyclopentadienyl) bis(dimethylamino)zirconium.

9. The catalyst composition as claimed in claim 7, wherein the metallocene catalyst is the unbridged metallocene represented by the formula (Z) (Z)MeQₖ, and is selected from the group consisting of
bis(η⁵-cyclopentadienyl)zirconium dichloride,
bis(η⁵-cyclopentadienyl)zirconium dimethyl,
bis(η⁵-cyclopentadienyl)titanium dichloride,
bis(η⁵-cyclopentadienyl)titanium dimethyl,
bis(η⁵-cyclopentadienyl)hafnium dichloride,
bis(η⁵-cyclopentadienyl)hafnium dimethyl,
bis(pentamethyl-η⁵-cyclopentadienyl)zirconium dichloride,
bis(pentamethyl-η⁵-cyclopentadienyl)zirconium dimethyl,
bis(pentamethyl-η⁵-cyclopentadienyl)titanium dichloride,
bis(pentamethyl-η⁵-cyclopentadienyl)titanium dimethyl,
bis(pentamethyl-η⁵-cyclopentadienyl)hafnium dichloride,
bis(pentamethyl-η⁵-cyclopentadienyl)hafnium dimethyl,
bis(η⁵-1-indenyl)zirconium dichloride, and
bis(η⁵-1-indenyl)zirconium dimethyl.

10. The catalyst composition as claimed in claim 6, wherein the metallocene is a mono(unsubstitued or substituted cyclopentadienyl) metal compound and is selected from the group consisting of
η⁵-cyclopentadienyltitanium trichloride,
η5-cyclopentadienyltitanium trimethyl,
(tert-butylamido)dimethyl(tetramethyl-η⁵-cyclopentadienyl)silanetitanium dichloride,
(tert-butylamido)dimethyl(tetramethyl-η⁵-cyclopentadienyl)silanetitanium dimethyl,
(tert-butylamido)dimethyl(tetramethyl-η⁵-cyclopentadienyl)silanezirconium dichloride, and
(tert-butylamido)dimethyl(tetramethyl-η⁵-cyclopentadienyl)silanezirconium dimethyl.

11. The catalyst composition as claimed in claim 1, further comprising an activating cocatalyst selected from the group consisting of methyl aluminoxane, alkyl aluminoxane, a trialkyl aluminum, a dialkyl aluminum halide, a salt of an inert and non-coordinating anion, and mixtures thereof.

12. The catalyst composition as claimed in claim 11, wherein the activating cocatalyst is methyl aluminoxane.

13. The catalyst composition as claimed in claim 12, wherein methyl aluminoxane is present in an amount such that the molar ratio of aluminum content in methyl aluminoxane to the metal content in metallocene is from 0 to 200.

14. The catalyst composition as claimed in claim 13, wherein methyl aluminoxane is present in an amount such that the molar ratio of aluminum content in methyl aluminoxane to the metal content in metallocene is from 50 to 150.

15. A process for preparing an olefin polymer, comprising the step of
(1) polymerizing an olefin, or
(2) copolymerizing an olefin with at least one monomer different from the olefin, under polymerizing conditions in the presence of a catalytically effective amount of the catalyst composition as claimed in claim 1.

16. The process as claimed in claim 15, wherein the process comprises polymerizing an olefin and the olefin is ethylene.

17. The process as claimed in claim 16, wherein the olefin polymer obtained is a polyethylene having a melting point higher than 140° C. in a weight molecular weight range less than 1,000,000.

18. The process as claimed in claim 15, wherein the process comprises polymerizing an olefin, wherein the olefin is propylene and the olefin polymer obtained is high isotactic polypropylene.

19. The process as claimed in claim 15, wherein the process comprises polymerizing an olefin, wherein the olefin is butadiene, and the olefin polymer obtained is high cis polybutadiene.

20. The process as claimed in claim 15, wherein the process comprises polymerizing an olefin, wherein the olefin is isoprene, and the olefin polymer obtained is high cis polyisoprene.
